(19) United States
(12) Patent Application Publication
(10) Pub. No.: US 2024/0143922 A1
(43) Pub. Date: May 2, 2024

(54) SYSTEM AND METHOD OF GENERATING KNOWLEDGE GRAPH AND SYSTEM AND METHOD OF USING THEREOF

(71) Applicant: NATIONAL CHENG KUNG UNIVERSITY, Tainan City (TW)

(72) Inventors: Wen-Hsiang LU, Tainan City (TW); Chia-Ming TUNG, Tainan City (TW); Ding-Jhe LIOU, Tainan City (TW)

(73) Assignee: NATIONAL CHENG KUNG UNIVERSITY, Tainan City (TW)

(21) Appl. No.: 17/986,782

(22) Filed: Nov. 14, 2022

(30) Foreign Application Priority Data
Oct. 26, 2022 (TW) 111140554

(51) Int. Cl. G06F 40/284; G06F 40/117; G06F 40/253; G06F 40/35; G06N 5/02

(52) U.S. Cl. CPC G06F 40/284; G06F 40/117; G06F 40/253; G06F 40/35; G06N 5/022

(57) ABSTRACT

A method of generating knowledge graph, performed by a processing device, includes: obtaining a knowledge document, performing word segmentation and part-of-speech tagging on the knowledge document to generate a number of tagged words, obtaining a number of sentences from the tagged words according to a default sentence pattern, wherein each of the sentences includes a subject, an adverb, a verb and an object, and the adverb corresponding to an adverb type, for each of the sentences, performing: using the subject as a first entity of a triple, using the object as a second entity of the triple, and using the adverb type and the verb as a relation in the triple, and forming a knowledge graph using the triple corresponding to each of the sentences.

### CROSS-REFERENCE TO RELATED APPLICATIONS

This non-provisional application claims priority under 35 U.S.C. § 119 (a) on Patent Application No (s). 111140554 filed in Republic of China (ROC) on Oct. 26 th, 2022, the entire contents of which are hereby incorporated by reference.

### BACKGROUND

### 1. Technical Field

This disclosure relates to a system and method of generating knowledge graph and system and method of using thereof.

### 2. Related Art

In recent years, knowledge graph is widely used in chat bots and question-answering systems, such as medical knowledge graphs, financial knowledge graphs, e-commerce graphs, etc., to assist in understanding human language and knowledge reasoning, and to enhance the user experience with chat bots. A knowledge graph formed of nodes (entities) and edges (relationships) allows users to find answers more quickly or provide information about search results that users did not expect.

However, the existing knowledge graph technology does not deal with the problem of knowledge conflict, so that some knowledge cannot be expressed correctly. Further, existing semantic analysis for constructing knowledge graphs is superficial and direct, and does not deal with the connotation of deep semantics.

### SUMMARY

Accordingly, this disclosure provides a system and method of generating knowledge graph and system and method of using thereof.

According to one or more embodiment of this disclosure, a method of generating knowledge graph, performed by a processing device, includes: obtaining a knowledge document; performing word segmentation and part-of-speech tagging on the knowledge document to generate a number of tagged words; obtaining a number of sentences from the tagged words according to a default sentence pattern, wherein each of the sentences comprises a subject, an adverb, a verb and an object, and the adverb corresponding to an adverb type; for each of the sentences, performing: using the subject as a first entity of a triple; using the object as a second entity of the triple; and using the adverb type and the verb as a relation in the triple; and forming a knowledge graph using the triple corresponding to each of the sentences.

According to one or more embodiment of this disclosure, a system of generating knowledge graph includes: a memory and a processing device. The memory stores a knowledge document. The processing device is connected to the memory, and configured to perform: obtaining the knowledge document; performing word segmentation and part-of-speech tagging on the knowledge document to generate a plurality of tagged words; obtaining a number of sentences from the tagged words according to a default sentence pattern, wherein each of the sentences comprises a subject, an adverb, a verb and an object, and the adverb corresponding to an adverb type; for each of the sentences, performing: using the subject as a first entity of a triple; using the object as a second entity of the triple; and using the adverb type and the verb as a relation in the triple; and forming a knowledge graph using the triple corresponding to each of the sentences.

In view of the above description, the system and method of generating knowledge graph according to one or more embodiments of the present disclosure may be applied to generate an organized knowledge graph, and the connection between information and information and knowledge reasoning may be more efficient and more accurate. In addition, the present disclosure uses the adverb type of the adverb as the relation between two entities, which helps solving the problem of knowledge conflict, allows deeper semantic connotation may be processed for knowledge to be expressed more correctly, and improves the expansion of knowledge graph.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a system of generating knowledge graph according to an embodiment of the present disclosure;

FIG. 2 is a flow chart illustrating a method of generating knowledge graph according to an embodiment of the present disclosure;

FIG. 3 is a schematic diagram illustrating a knowledge graph according to an embodiment of the present disclosure;

FIG. 4 is a flow chart illustrating a method of generating knowledge graph according to another embodiment of the present disclosure;

FIG. 5 is a block diagram illustrating a system of using knowledge graph according to an embodiment of the present disclosure;

FIG. 6 is a flow chart illustrating a method of using knowledge graph according to an embodiment of the present disclosure; and

FIG. 7 is a flow chart illustrating a method of using knowledge graph according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

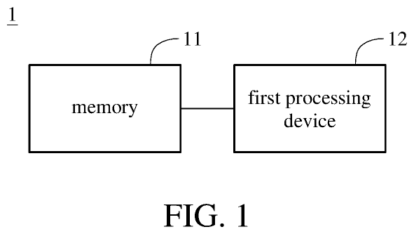

Please refer to FIG. 1, FIG. 1 is a block diagram illustrating a system of generating knowledge graph according to an embodiment of the present disclosure. The system of generating knowledge graph 1 according to an embodiment of the present disclosure includes a memory 11 and a first processing device 12. The memory 11 may be in communication connection with the first processing device 12 or electrically connected to the first processing device 12. The memory 11 may be a non-volatile memory, such as a read-only memory (ROM), a flash memory or a non-volatile random access memory (NVRAM) etc., the present disclosure is not limited thereto. The first processing device 12 may be a central processing unit, a programmable logic device or an application specific integrated circuit etc., the present disclosure is not limited thereto.

The memory 11 is configured to store knowledge documents corresponding to various fields of knowledge, and the first processing device 12 is configured to generate knowledge graphs corresponding to various fields of knowledge according to the knowledge documents, and store the knowledge graphs into the memory 11 or other memories. The first processing device 12 may periodically or non-periodically execute web crawler on various web sites, to store the knowledge documents into the memory 11. The knowledge documents may include internal knowledge document and external knowledge document. For example, assuming that the field of knowledge is medicine, the internal knowledge document may include health educational articles published by the hospital, and the external knowledge document may include medicine articles on Wikipedia, medicine journals and food and drug administration web sites of various countries, the present disclosure does not limit the source of the knowledge documents.

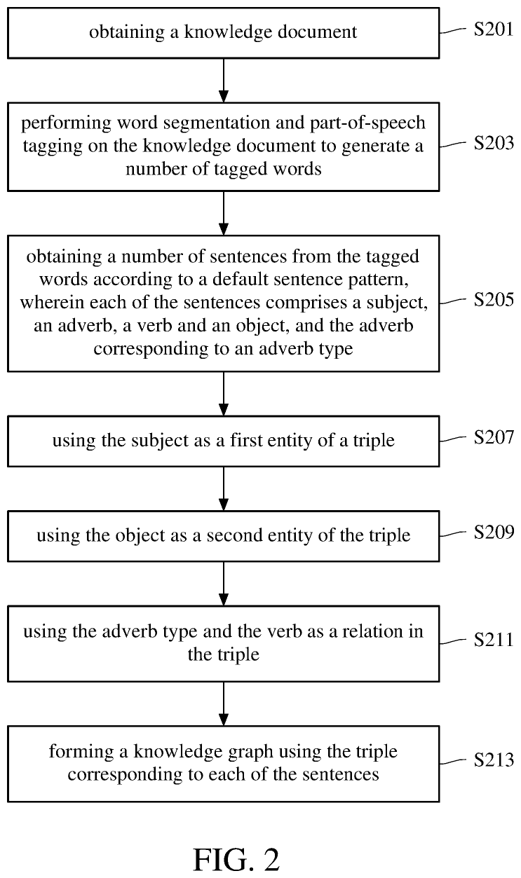

To explain the method of generating knowledge graph in more detail, please refer to FIG. 1 and FIG. 2, wherein FIG. 2 is a flow chart illustrating a method of generating knowledge graph according to an embodiment of the present disclosure. As shown in FIG. 2, method of generating knowledge graph according to an embodiment of the present disclosure, performed by the first processing device 12, includes: step S201: obtaining a knowledge document; step S203: performing word segmentation and part-of-speech tagging on the knowledge document to generate a number of tagged words; step S205: obtaining a number of sentences from the tagged words according to a default sentence pattern, wherein each of the sentences comprises a subject, an adverb, a verb and an object, and the adverb corresponding to an adverb type; for each of the sentences, performing: step S207: using the subject as a first entity of a triple; step S209: using the object as a second entity of the triple; and step S211: using the adverb type and the verb as a relation in the triple; and step S213: forming a knowledge graph using the triple corresponding to each of the sentences. The following description uses the knowledge document related to medicine as an example.

In step S201, the first processing device 12 obtains the knowledge document from the memory 11. In step S203, the first processing device 12 performs the word segmentation and the part of speech tagging (POS tagging) on the knowledge document to generate the tagged words, wherein the first processing device 12 may use a part-of-speech tagger to perform the POS tagging. For example, assuming that one of the sentences in the knowledge document is “Patients suffered from bone fracture can consume calcium, cheese and bone broth”. Then, the first processing device 12 performs the word segmentation on the sentence to obtain words “bone fracture”, “can”, “consume”, “cheese”, “calcium” and “bone broth”. The first processing device 12 performs the POS tagging on these words to obtain the tagged words “patients suffered from bone fracture subject”, “can adverb”, “consume verb”, “cheese object”, “calcium object” and “bone broth object”.

In step S205, the first processing device 12 obtains sentences from these tagged words according to the default sentence, wherein the default sentence is, for example, “subject-adverb-verb-object”. For example, the first processing device 12 may obtain three sentences according to the default sentence, which respectively are “Patients suffered from bone fracture can consume cheese”, “Patients suffered from bone fracture can consume calcium” and “Patients suffered from bone fracture can consume bone broth”.

In addition, the adverb has a corresponding adverb type. The adverb type may include positive type, negative type, high-frequency type and low-frequency type. The positive type is used to indicate a positive relationship between the subject and the object; the negative type is used to indicate a negative relationship between the subject and the object; the high-frequency type is used to indicate a positive relationship between the subject and the object, and when a situation corresponding to the subject occurs, a frequency of using/performing a content of the object may be increased; and the low-frequency type is used to indicate a negative relationship between the subject and the object, and when a situation corresponding to the subject occurs, a frequency of using/performing a content of the object may be reduced.

For example, the adverb type of the adverb “can” in the above example is the positive type, meaning that when a situation of bone fracture occurs, the person may consume cheese, calcium and bone broth. In other examples of the subject being “bone fracture”, assuming that the object is “weight training”, and the adverb type between “bone fracture” (the subject) and “weight training” (the object) is the negative type, it means that a person suffered from bone fracture should not perform weight training; assuming that the object is “rehabilitation” and the adverb type between “bone fracture” (the subject) and “rehabilitation” (the object) is the high-frequency type, it means that a person suffered from bone fracture can do more rehabilitation; and assuming that the object is “lying down” and the adverb type between “bone fracture” (the subject) and “lying down” (the object) is the low-frequency type, it means that a person suffered from bone fracture should not spend too much time lying down.

In addition, the memory 11 may store an adverb type table as shown below, for the first processing device 12 to determine the adverb type of the adverb.

The adverb type table

| Type | Words for adverb |
|---|---|
| positive type | more often, recommend, fit, best, recommended, |
| | suggested, should, must, have to, require, necessary, |
| | need, may, can, suitable, appropriate, suitable, favorable |
| negative type | forbidden, ban, not allowed, taboo, no need, can't, no, |
| | absolutely can't, must not, don't, avoid, not |
| | recommended, unsuitable, should not, improper, not |
| | suitable, never |
| high-frequency | more, increase, often |
| type | |
| low-frequency | less, reduce, decrease, lower, cut back, minimize |
| type | |

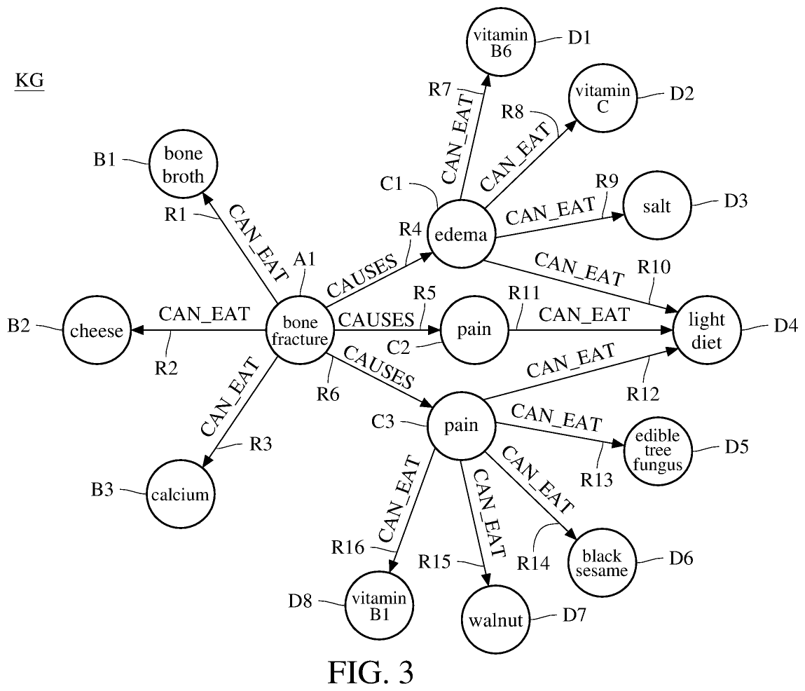

The first processing device 12 performs step S203 and step S205 on the knowledge document for multiple times to obtain the sentences. Then, the first processing device 12 performs step S207, step S209 and step S211 on each of the sentences. To explain the content of step S207, step S209 and step S211 in more detail, please refer to FIG. 3, wherein FIG. 3 is a schematic diagram illustrating a knowledge graph according to an embodiment of the present disclosure.

In step S207, the first processing device 12 uses the subject “bone fracture” as the first entity A1 of the triple; in step S209, the first processing device 12 uses the object “bone broth” as the second entity B1 of the triple; and in step S211, the first processing device 12 uses the positive type of the adverb “can” and the verb “consume” as the relation R1 between the first entity A1 and the second entity B1. Similarly, the first processing device 12 uses the object “cheese” as the second entity B2 of the triple, and uses the positive type of the adverb “can” and the verb “consume” as the relation R2 between the first entity A1 and the second entity B2; and uses the object “calcium” as the second entity B3 of the triple, and uses the positive type of the adverb “can” and the verb “consume” as the relation R3 between the first entity A1 and the second entity B3.

It should be noted that, for better understanding, the relations between the first entity A1 and the second entities B1 to B3 shown in FIG. 3 are represented in the form of the adverb and the verb (CAN EAT), but the relations between the first entity A1 and the second entities B1 to B3 may be represented in the form of the positive type, the negative type, the high-frequency type and the low-frequency type along with the corresponding verb.

Then, in step S213, the first processing device 12 builds the knowledge graph KG by the triples generated by performing step S207, step S209 and step S211 on each of the sentences. For example, the first processing device 12 may use the first entity A1, the second entities B1 to B3 and the relations R1 to R3 as one knowledge graph. In addition, the first processing device 12 may tag the knowledge graph KG according to the knowledge field of the knowledge graph KG, for the knowledge graph KG to have a corresponding field header. Take FIG. 3 as an example, the field header of the knowledge graph KG may be “medicine”, “orthopedics”, or “bone fracture” etc. Therefore, the knowledge graph KG may be quickly searched based on the field header.

In addition, as shown in FIG. 3, the knowledge graph KG may further include third entities C1 to C3 connected to the first entity A1, wherein the relations R4 to R6 between the first entity A1 and the third entities C1 to C3 are verbs. Method of generating the third entities C1 to C3 may be the same as the method of generating the second entities B1 to B3. When the sentence does not include the adverb, the first processing device 12 may also use the subject as the first entity A1 of the triple, the object as the third entities C1 to C3 of the triple, and the verbs between the subject and the objects as the relations R4 to R6 between the first entity A1 and the third entities C1 to C3 of the triple.

Further, as shown in FIG. 3, the third entities C1 to C3 generated based on the object may be further connected to fourth entities D1 to D8 generated based on other objects. For example, assuming that the knowledge document further includes a description of “A person with edema can consume vitamin B6”, then the tagged words “edema subject”, “can adverb”, “consume verb” and “vitamin B6 object” may be obtained based on step S203 and step S205.

Therefore, in step S207, the first processing device 12 uses the entity C1 of “edema (subject)” as the first entity of the triple; in step S209, the first processing device 12 uses the object “vitamin B6” as the second entity of the triple (referred to as the fourth entity D1 herein); and in step S211, the first processing device 12 uses the positive type of the adverb “can” and the verb “consume” as the relation R7 between the third entity C1 and the fourth entity D1. In other words, the entity generated based on the object may be seen as the first entity described above, to expand the knowledge graph KG accordingly.

The above description uses the knowledge document related to medicine for example, the system and method of generating knowledge graph according to one or more embodiments of the present disclosure may also be applied to other fields, such as manufacturing industry, news, politics or international affairs etc.

Take manufacturing industry as an example, assuming that a knowledge document has a description of “The performance of the overall manufacturing industry in the first half of the year is not inferior to that of the same period in 2021, and even the performances of semiconductor industry, textile industry, electrical machinery and machinery industry are better than the same period in 2021”, the tagged words obtained by the first processing device 12 performing step S203 may include “performance of the overall manufacturing industry in the first half_subject”, “not_adverb”, “inferior to_verb” and “same period in 2021_object”. The first processing device 12 performs step S205 to obtain the sentence of “performance of the overall manufacturing industry in the first half (subject) not (adverb) inferior to (verb) same Period in 2021 (object)” according to the default sentence. Then, the first processing device 12 performs step S207, step S209 and step S211 to obtain the triple of the first entity (performance of the overall manufacturing industry in the first half), the second entity (same period in 2021) and the relation (not inferior to).

In addition, for “even the performances of semiconductor industry, textile industry, electrical machinery and machinery industry are better than the same period in 2021”, the tagged words obtained by the first processing device 12 performing step S203 may include “performances of semiconductor industry, textile industry, electrical machinery and machinery industry_subject”, “even_adverb”, “are better than_verb” and “same period in 2021_object”. The first processing device 12 performs step S205 to obtain the sentence of “performances of semiconductor industry, textile industry, electrical machinery and machinery industry (subject) even (adverb) are better than (verb) same period in 2021 (object)” according to the default sentence. Then, the first processing device 12 performs step S207, step S209 and step S211 to obtain the triple of the first entity (performances of semiconductor industry, textile industry, electrical machinery and machinery industry), the second entity (same period in 2021) and the relation (even better than). In this example, the adverb and the verb may be directly used as the relation between the first entity and the second entity.

Therefore, in this example, the entity “performance of the overall manufacturing industry in the first half” and the entity “performances of semiconductor industry, textile industry, electrical machinery and machinery industry” may both be connected to the entity “same period in 2021”.

Also take manufacturing industry as an example, assuming that a knowledge document has a description of “Except for the non-metallic mineral products industry, which is a newly entered industry, the other four industries all belong to the top five industries in gross profit margin”, the tagged words obtained by the first processing device 12 performing step S203 may include “the other four industries subject”, “except for the non-metallic mineral products industry, which is a newly entered industry adverb”, “all adverb”, “belong to verb” and “the top five industries in gross profit margin object”. The first processing device 12 performs step S205 to obtain the sentence of “the other four industries (subject) except for the non-metallic mineral products industry, which is a newly entered industry (adverb) belong to (verb) the top five industries in gross profit margin (object)” according to the default sentence. Then, the first processing device 12 performs step S207, step S209 and step S211 to obtain the triple of the first entity (the other four industries), the second entity (the top five industries in gross profit margin) and the relation (all belong to), and to form the knowledge graph accordingly. In this example, the adverb and the verb may be directly used as the relation between the first entity and the second entity.

Take manufacturing industry as another example, assuming that a knowledge document has a description of “The rubber and plastic industry topped the list for the first time”, the tagged words obtained by the first processing device 12 performing step S203 may include “rubber and plastic industry subject”, “for the first time adverb”, “topped verb” and “the list object”. The first processing device 12 performs step S205 to obtain the sentence of “rubber and plastic industry (subject) for the first time (adverb) topped (verb) the list (object)” according to the default sentence. Then, the first processing device 12 performs step S207, step S209 and step S211 to obtain the triple of the first entity (rubber and plastic industry), the second entity (the list) and the relation (topped for the first time), and to form the knowledge graph accordingly. In this example, the adverb and the verb may be directly used as the relation between the first entity and the second entity.

Take news as an example, assuming that a news article (knowledge document) has a description of “The designer of Hsinchu baseball stadium did not respect professional opinion”, the tagged words obtained by the first processing device 12 performing step S203 may include “designer of Hsinchu baseball stadium subject”, “not adverb”, “respect verb” and “professional opinion object”. The first processing device 12 performs step S205 to obtain the sentence of “designer of Hsinchu baseball stadium (subject) not (adverb) respect (verb) professional opinion (object)” according to the default sentence. Then, the first processing device 12 performs step S207, step S209 and step S211 to obtain the triple of the first entity (designer of Hsinchu baseball stadium), the second entity (professional opinion) and the relation (not respect), and to form the knowledge graph accordingly. In this example, the adverb and the verb may be directly used as the relation between the first entity and the second entity.

Take international affairs as an example, assuming that a news article (knowledge document) has a description of “EU member states cut gas consumption across the board”, the tagged words obtained by the first processing device 12 performing step S203 may include “EU member states subject”, “across the board adverb”, “cut verb” and “gas consumption object”. The first processing device 12 performs step S205 to obtain the sentence of “EU member states (subject) across the board (adverb) cut (verb) gas consumption (object)” according to the default sentence. Then, the first processing device 12 performs step S207, step S209 and step S211 to obtain the triple of the first entity (EU member states), the second entity (gas consumption) and the relation (cut across the board), and to form the knowledge graph accordingly. In this example, the adverb and the verb may be directly used as the relation between the first entity and the second entity.

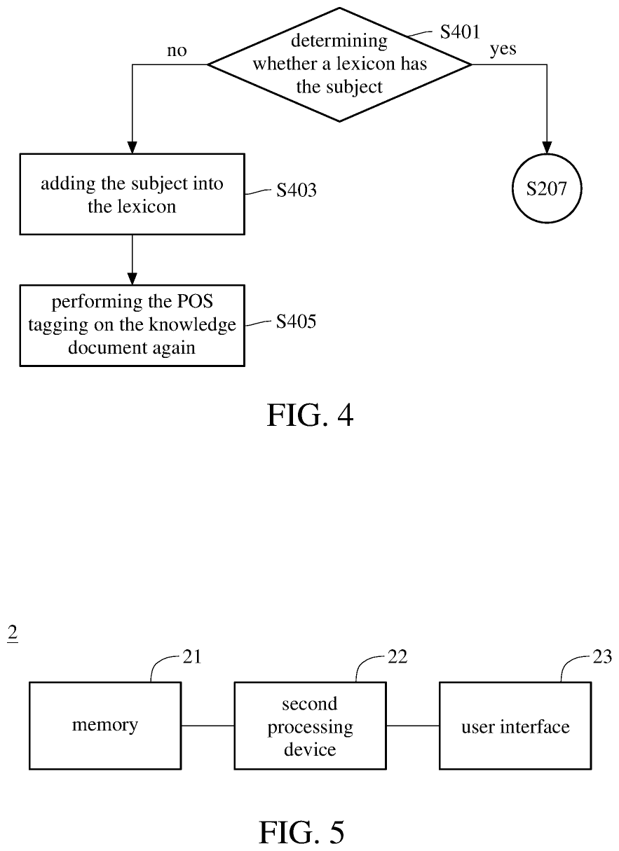

Please refer to FIG. 1 and FIG. 4, wherein FIG. 4 is a flow chart illustrating a method of generating knowledge graph according to another embodiment of the present disclosure. Steps S401, S403 and S405 shown in FIG. 4 may be performed after the first processing device 12 obtains the subject and before the first entity is generated. That is, steps S401, S403 and S405 shown in FIG. 4 may be performed between step S205 and step S207 shown in FIG. 2. As shown in FIG. 4, after obtaining the subject, the first processing device 12 may further perform: step S401: determining whether a lexicon has the subject; if the determination result of step S401 is “no”, performing step S403: adding the subject into the lexicon; and step S405: performing the POS tagging on the knowledge document again. In addition, if the determination result of step S401 is “yes”, the first processing device 12 may perform step S207 shown in FIG. 2.

The first processing device 12 may be connected to the lexicon (has access to the lexicon), wherein the lexicon may be stored in the memory 11. Therefore, after obtaining the subject through step S205 shown in FIG. 2, in step S401, the first processing device 12 may first determine whether the subject exits in the lexicon.

If the first processing device 12 determines that the lexicon has the subject, the first processing device 12 may perform step S207 shown in FIG. 2. If the first processing device 12 determines that the lexicon does not have the subject, in step S403, the first processing device 12 may add the subject into the lexicon, and perform the POS tagging on the knowledge document again to generate a number of tagged words.

In other words, after finding a new word, the first processing device 12 may first add said new word into the current lexicon, and then perform extraction of entity relation on the knowledge document. Accordingly, the existing knowledge graph may be expanded and be more complete.

Please refer to FIG. 5, wherein FIG. 5 is a block diagram illustrating a system of using knowledge graph according to an embodiment of the present disclosure. As shown in FIG. 5, the system of using knowledge graph 2 includes a memory 21, a second processing device 22 and a user interface 23. The second processing device 22 is electrically connected to or in communication connection with the memory 21 and the user interface 23. The memory 21 may be a non-volatile memory, such as a read-only memory (ROM), a flash memory or a non-volatile random access memory (NVRAM) etc., the present disclosure is not limited thereto. The memory 21 may store a number of knowledge graphs generated according to the system and method of generating knowledge graph according to embodiments of the present disclosure, the following refers to these knowledge graphs as candidate knowledge graphs. In addition, the memory 21 may further store the knowledge documents described above. The second processing device 22 may be a central processing unit, a programmable logic device or an application specific integrated circuit etc., the present disclosure is not limited thereto. The user interface 23 may be a screen, a touch display interface and an audio device etc., the user interface 23 may be any element that can be used to receive user command and present information.

The memory 21 shown in FIG. 5 and the memory 11 shown in FIG. 1 may be the same memory, the memory 21 shown in FIG. 5 may also be another memory different from that of FIG. 1; the second processing device 22 shown in FIG. 5 and the first processing device 12 shown in FIG. 1 may be the same processing device, the second processing device 22 shown in FIG. 5 may also be another processing device different from that of FIG. 1.

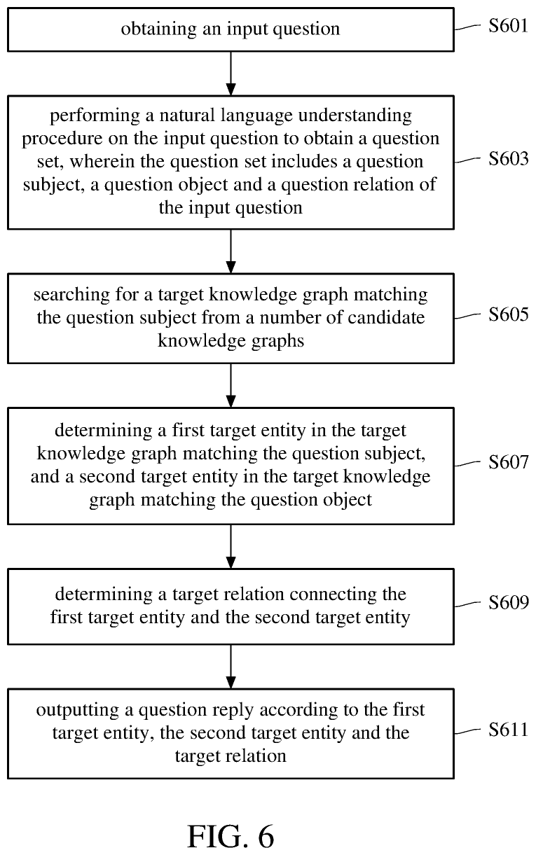

To explain method of using candidate knowledge graphs generated according to the above embodiments in more detail, please refer to FIG. 5 and FIG. 6, wherein FIG. 6 is a flow chart illustrating a method of using knowledge graph according to an embodiment of the present disclosure.

As shown in FIG. 6, which is a flow chart illustrating a method of using knowledge graph according to an embodiment of the present disclosure, said method, performed by the second processing device 22, includes: step S601: obtaining an input question; step S603: performing a natural language understanding procedure on the input question to obtain a question set, wherein the question set includes a question subject, a question object and a question relation of the input question; step S605: searching for a target knowledge graph matching the question subject from a number of candidate knowledge graphs; step S607: determining a first target entity in the target knowledge graph matching the question subject, and a second target entity in the target knowledge graph matching the question object; step S609: determining a target relation connecting the first target entity and the second target entity; and step S611: outputting a question reply according to the first target entity, the second target entity and the target relation.

In step S601, the user interface 23 obtains the input question inputted by the user, and transmits the input question to the second processing device 22. In step S603, the second processing device 22 performs natural language understanding (NLU) procedure on the input question, to parse the syntax or semantics of the input question, thereby obtaining the question set, wherein the question set includes the question subject, the question object and the question relation of the input question. For example, assuming that the input question is “Can patients suffered from bone fracture consume cheese?”, the second processing device 22 may obtain the question subject of “bone fracture”, the question object “cheese” and the question relation “can consume” through the natural language understanding procedure. In other words, through the natural language understanding procedure, the second processing device 22 may understand that the user is asking whether a relation between the entity “bone fracture” and the entity “cheese” is “can eat”. It should be noted that, assuming that the question relation of the input question is “can eat”, the second processing device 22 may determine that “consume” and “eat” are synonyms through natural language understanding.

In step S605, the second processing device 22 searches for a knowledge graph, among the candidate knowledge graphs stored in the memory 21, matching the question subject as the target knowledge graph. As described above, each candidate knowledge graph may have a corresponding field header, the second processing device 22 may search for the target knowledge graph according to the question subject and the field header. For example, in the example of the question subject being “bone fracture”, the second processing device 22 may use the candidate knowledge graph with the field header of “bone fracture” as the target knowledge graph.

In step S607 and step S609, the second processing device 22 determines the first target entity in the target knowledge graph that matches the question subject, the second target entity in the target knowledge graph that matches the question object, and determines the target relation connecting the first target entity and the second target entity. Take the input question described above and FIG. 3 for example, the second processing device 22 determines that the entity in the knowledge graph KG matching the question subject “bone fracture” is the first target entity A1, and the entity in the knowledge graph KG matching the question object “cheese” is the second target entity B2, and determines that the relation connecting the first target entity A1 and the second target entity B2 is the target relation R2.

Then, in step S611, the second processing device 22 generates the question reply according to the first target entity A1, the second target entity B2 and the target relation R2, and outputs the question reply to the user interface 23. Specifically, because the target relation R2 indicates the verb and the corresponding adverb type between the first target entity A1 and the second target entity B2, the second processing device 22 may generate the question reply based on the relation between the first target entity A1 and the second target entity B2.

Take the above question subject “bone fracture” and the question object “cheese” for example, according to the knowledge graph KG, the second processing device 22 may determine that the target relation R2 between the entities of the subject and the object corresponding to is the positive type adverb and the verb “consume”. Accordingly, the second processing device 22 may generate a positive question reply, such as the question reply of “Yes, a patient suffered from bone fracture can consume cheese”.

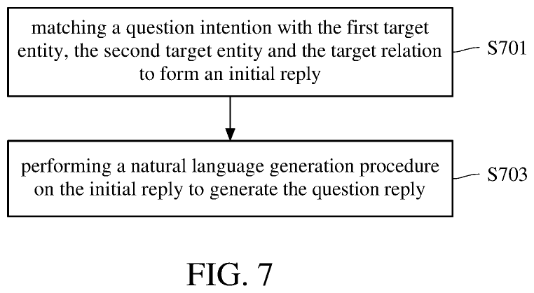

Please refer to FIG. 5 and FIG. 7, wherein FIG. 7 is a flow chart illustrating a method of using knowledge graph according to another embodiment of the present disclosure. Step S611 shown in FIG. 6 may include step S701 and step S703 shown in FIG. 7. As shown in FIG. 7, step S611 shown in FIG. 6 may include: step S701: matching a question intention with the first target entity, the second target entity and the target relation to form an initial reply; and step S703: performing a natural language generation procedure on the initial reply to generate the question reply.

In step S701, the second processing device 22 matches the first target entity A1, the second target entity B2 and the target relation R2 to from the initial reply “bone fracture_positive type_consume_cheese”. In step S703, the second processing device 22 performs the natural language generation (NLG) procedure on the initial reply to generate the question reply, such as the question reply of “Yes, a patient suffered from bone fracture can consume cheese” described above.

In view of the above description, the system and method of generating knowledge graph according to one or more embodiments of the present disclosure may be applied to generate an organized knowledge graph, and the connection between information and information and knowledge reasoning may be more efficient and more accurate. In addition, the present disclosure uses the adverb type of the adverb as the relation between two entities, which helps solving the problem of knowledge conflict, allows deeper semantic connotation may be processed for knowledge to be expressed more correctly, and improves the expansion of knowledge graph. In addition, the system and method of generating knowledge graph according to one or more embodiments of the present disclosure further discloses adding a new word into the lexicon and performing extraction of entity relation on the knowledge document again. Accordingly, the existing knowledge graph may be expanded and be more complete. In addition, the system and method of using knowledge graph according to one or more embodiments of the present disclosure may provide a correct response or suggestion to the user.

What is claimed is:

1. A method of generating knowledge graph, performed by a processing device, comprising:
obtaining a knowledge document;
performing word segmentation and part-of-speech tagging on the knowledge document to generate a plurality of tagged words;
obtaining a plurality of sentences from the tagged words according to a default sentence pattern, wherein each of the sentences comprises a subject, an adverb, a verb and an object, and the adverb corresponding to an adverb type;
for each of the sentences, performing:
using the subject as a first entity of a triple;
using the object as a second entity of the triple; and
using the adverb type and the verb as a relation in the triple; and
forming a knowledge graph using the triple corresponding to each of the sentences.

2. The method of generating knowledge graph according to claim 1, wherein the processing device is connected to a lexicon, and after obtaining the subject, the method further comprising:
determining whether the lexicon has the subject;
adding the subject into the lexicon when the lexicon does not have the subject; and
performing the part-of-speech tagging on the knowledge document again.

3. A method of using knowledge graph, performed by a first processing device, comprising:
obtaining an input question;
performing a natural language understanding procedure on the input question to obtain a question set, wherein the question set comprises a question subject, a question object and a question relation of the input question;
searching for a target knowledge graph matching the question subject from a plurality of candidate knowledge graphs generated according to the method of generating knowledge graph according to claim 1;
determining a first target entity in the target knowledge graph matching the question subject, and a second target entity in the target knowledge graph matching the question object;
determining a target relation connecting the first target entity and the second target entity; and
outputting a question reply according to the first target entity, the second target entity and the target relation.

4. The method of using knowledge graph according to claim 3, wherein the question set further comprises a question intention, and outputting the question reply according to the first target entity, the second target entity and the target relation comprises:
matching the question intention with the first target entity, the second target entity and the target relation to form an initial reply; and
performing a natural language generation procedure on the initial reply to generate the question reply.

5. A method of using knowledge graph, performed by a first processing device, comprising:
obtaining an input question;
performing a natural language understanding procedure on the input question to obtain a question set, wherein the question set comprises a question subject, a question object and a question relation of the input question;
searching for a target knowledge graph matching the question subject from a plurality of candidate knowledge graphs generated according to the method of generating knowledge graph according to claim 2;
determining a first target entity in the target knowledge graph matching the question subject, and a second target entity in the target knowledge graph matching the question object;
determining a target relation connecting the first target entity and the second target entity; and
outputting a question reply according to the first target entity, the second target entity and the target relation.

6. A system of generating knowledge graph, comprising:
a memory storing a knowledge document; and
a processing device connected to the memory, and configured to perform:
obtaining the knowledge document;
performing word segmentation and part-of-speech tagging on the knowledge document to generate a plurality of tagged words;
obtaining a plurality of sentences from the tagged words according to a default sentence pattern, wherein each of the sentences comprises a subject, an adverb, a verb and an object, and the adverb corresponding to an adverb type;
for each of the sentences, performing:
using the subject as a first entity of a triple;
using the object as a second entity of the triple; and
using the adverb type and the verb as a relation in the triple; and
forming a knowledge graph using the triple corresponding to each of the sentences.

7. The system of generating knowledge graph according to claim 6, wherein the processing device is connected to a lexicon, and after obtaining the subject, the processing device is further configured to perform:
determining whether the lexicon has the subject;
adding the subject into the lexicon when the lexicon does not have the subject; and
performing the part-of-speech tagging on the knowledge document again.

8. A system of using knowledge graph, comprising:
a memory storing a plurality of candidate knowledge graphs generated according to the method of generating knowledge graph according to claim 1;
a user interface configured to obtain an input question and present a question reply corresponding to the input question; and
a first processing device connected to the memory and the user interface, and configured to perform:
performing a natural language understanding procedure on the input question to obtain a question set, wherein the question set comprises a question subject, a question object and a question relation of the input question;
searching for a target knowledge graph matching the question subject from the plurality of candidate knowledge graphs;
determining a first target entity in the target knowledge graph matching the question subject, and a second target entity in the target knowledge graph matching the question object;
determining a target relation connecting the first target entity and the second target entity; and
outputting the question reply according to the first target entity, the second target entity and the target relation.

9. The system of using knowledge graph according to claim 8, the question set further comprises a question intention, and the first processing device performing outputting the question reply according to the first target entity, the second target entity and the target relation comprises:
matching the question intention with the first target entity, the second target entity and the target relation to form an initial reply; and
performing a natural language generation procedure on the initial reply to generate the question reply.

10. A system of using knowledge graph, comprising:
a memory storing a plurality of candidate knowledge graphs generated according to the method of generating knowledge graph according to claim 2;
a user interface configured to obtain an input question and present a question reply corresponding to the input question; and
a first processing device connected to the memory and the user interface, and configured to perform:
performing a natural language understanding procedure on the input question to obtain a question set, wherein the question set comprises a question subject, a question object and a question relation of the input question;
searching for a target knowledge graph matching the question subject from the plurality of candidate knowledge graphs;
determining a first target entity in the target knowledge graph matching the question subject, and a second target entity in the target knowledge graph matching the question object;
determining a target relation connecting the first target entity and the second target entity; and
outputting the question reply according to the first target entity, the second target entity and the target relation.
